(19) United States
(12) Patent Application Publication
(10) Pub. No.: US 2017/0021848 A1
(43) Pub. Date: Jan. 26, 2017

(54) Poster Storage, Display, and Carrying Case for Teachers

(71) Applicant: Kimberly Linkenhoker, San Antonio, TX (US)

(72) Inventor: Kimberly Linkenhoker, San Antonio, TX (US)

(21) Appl. No.: 14/808,260

(22) Filed: Jul. 24, 2015

(51) Int. Cl. B62B 1/26; A45C 13/26; A45C 13/02; A45C 11/24; A45C 13/00

(52) U.S. Cl. CPC B62B 1/268; A45C 11/24; A45C 13/005; A45C 13/02; A45C 13/262

(57) ABSTRACT

A durable, light-weight carrying case particularly suited to the needs of classroom teachers is disclosed. This case is especially designed for the storage, display, and transport of multiple flat, thin, oversized items such as poster boards, desk-top calendars, project tri-fold boards, jumbo story books, teaching posters, and pictures. The case may be easily transported from one location to another throughout the class day. The case provides a solution for long-term storage at the end of a school year or short-term transport between classrooms during the school day. The case is preferably composed of a durable light-weight transparent plastic with multiple clear dividers to protect items from moisture, bending, and tearing, while permitting identification and display. The case has a hinged lid to protect and secure stored items, a handle for carrying, and a wheel assembly for rolling transport. The base is flat for upright access, display of contents, or storage.

### BACKGROUND OF THE INVENTION

1. Field of the Invention

The present invention relates generally to improvements in portable storage devices. Specifically, the present invention relates to a poster storage, display and carrying case particularly suited to the needs of classroom teachers.

2. Description of the Related Art

A typical classroom teacher utilizes many large poster-size items in the daily curriculum throughout the school year. For a teacher who remains in a designated classroom throughout the day, large instructional charts, graphs, drawings, calendars, and photographs are used for organization, decoration, and instruction. The materials are changed during the school year according to the topics being taught, the season of the year, and the particular assignments and projects completed.

However, even for those teachers that move from room to room during the class day, large instructional materials are inevitably used. These items must be transported from one location to another throughout the day. Typically, they are rolled up and carried by hand to the next classroom. Then they are unrolled and positioned on a chalkboard behind items to hold them in place or tacked to a bulletin board. This results in significant wear and tear on the materials and considerable difficulty for the teacher in attempting to use and transport them.

At the end of the school year, season, semester, or curriculum unit, the teacher must remove the materials and store them for future use. Typically, this means rolling large posters into a cylindrical shape and securing them with rubber bands or the like and putting them on a shelf. Alternatively, the items are put in a cardboard box for storage in a closet.

Neither of these options yields favorable outcomes. Items which are rolled into a cylinder get frayed or torn corners, or worse yet, are flattened by heavy objects inadvertently placed on top of them during storage and left with permanent creases. If the teacher manages to keep the items in usable shape, once unrolled they will never lie flat again and must be secured with multiple tacks, hooks, tape, etc. Items placed in a cardboard box for storage are bent, torn, and sometimes spilled upon. Worse yet, items out of sight for extended periods may be forgotten completely.

None of the storage cases commonly used in everyday personal and business situations are designed for the special needs of a classroom teacher. Typical storage cases are not very different from a common cardboard box.

Thus, there is a need in the art for an economical, durable, and light-weight carrying case which would allow a teacher to safely store multiple large, flat, thin items and protect them from moisture, bending, and tearing, while simultaneously permitting ready identification, display, and transport.

### SUMMARY OF THE INVENTION

The present invention discloses a unique poster storage, display and carrying case particularly suited to the needs of classroom teachers. This case is especially designed for the storage, display, and transport of multiple flat, thin, oversized items such as poster boards, desk-top calendars, project tri-fold boards, jumbo story books, teaching posters, pictures, paintings, and photographs. The case provides a means of protecting the items during storage and transport. Moreover, the case allows the teacher to readily identify the items and display the items as needed. The case is light-weight and durable and thus capable of being easily transported from one location to another throughout the class day. Thus, the case provides a versatile solution for a variety of teacher needs, from long-term storage at the end of a school year to short-term transport between classrooms during the school day.

This carrying case is designed to be economically produced and may be of variable dimensions, shapes, and materials. The case is preferably composed of a durable light-weight transparent plastic and constructed using one of the molding techniques well known in the art such as injection molding, blow molding, or rotational molding.

The case can be constructed in multiple sizes to accommodate a variety of standard paper or cardboard items typically used in a classroom. For convenience, each size may be available in a unique color. The case has a lid to protect the stored items from dust, dirt, and spills. The lid is hinged for easy opening and has a rim with lid closure tabs that may be fastened to lid closure posts on the body of the case. The closure tabs provide a simple and secure means of keeping the lid fastened with little chance of damage or loss.

The case has a handle for carrying and lifting. Additionally, the case has two wheels positioned at one end for easy rolling transport. The base of the case is flat to allow the teacher to stand the case on end for ease of access, display of contents, or safe storage. In a preferred embodiment, the poster case incorporates rotatable stabilizer wings on the bottom face to further stabilize the case when standing.

The sides of the case are clear for easily displaying items for teaching or identification of contents. The interior of the case has multiple, clear dividers to allow the teacher to easily see the contents of the case and select an individual item quickly. The interior dividers are preferably fixed in position and composed of semi-rigid material to provide support for thin papers or other items that lack sufficient rigidity to stand alone.

Although there are many cases in the prior art, none of them provides a durable, light-weight solution for the storage, display, and transport of multiple oversized thin items. The ability to separate, protect, and visualize each item resolves a difficulty with prior art cases. The new device provides efficient storage space, easy viewing, and simple transport, thus greatly improving the ability of a classroom teacher to store, display, and transport over-sized posters and the like.

### BRIEF DESCRIPTION OF THE DRAWINGS

FIG. 1 is a perspective view of a preferred embodiment of the poster case of the present invention as it would appear when positioned on a table or on the floor.

FIG. 2 is a front elevation view of the preferred embodiment of the poster case of the present invention shown in FIG. 1.

FIG. 3 is a top plan view of the preferred embodiment of the poster case of the present invention shown in FIG. 1.

FIG. 4 is a left side elevation view of the preferred embodiment of the poster case of the present invention shown in FIG. 1.

FIG. 5 is a right side elevation view of the preferred embodiment of the poster case of the present invention shown in FIG. 1.

FIG. 6 is a bottom plan view of the preferred embodiment of the poster case of the present invention shown in FIG. 1.

FIG. 7 is a detailed perspective view of the handle side of the preferred embodiment of the poster case of the present invention shown in FIG. 1.

FIG. 8 is a detailed perspective view of the lid opening top of the preferred embodiment of the poster case of the present invention shown in FIG. 1.

FIG. 9 is a detailed perspective view of the wheel assembly of the preferred embodiment of the poster case of the present invention shown in FIG. 1.

FIG. 10 is a detailed perspective view of a preferred embodiment of the poster case of the present invention incorporating optional stabilizer wings on the bottom face.

FIG. 11 is a bottom plan view of a preferred embodiment of the poster case of the present invention incorporating optional stabilizer wings on the bottom face.

### DETAILED DESCRIPTION OF THE PREFERRED EMBODIMENTS

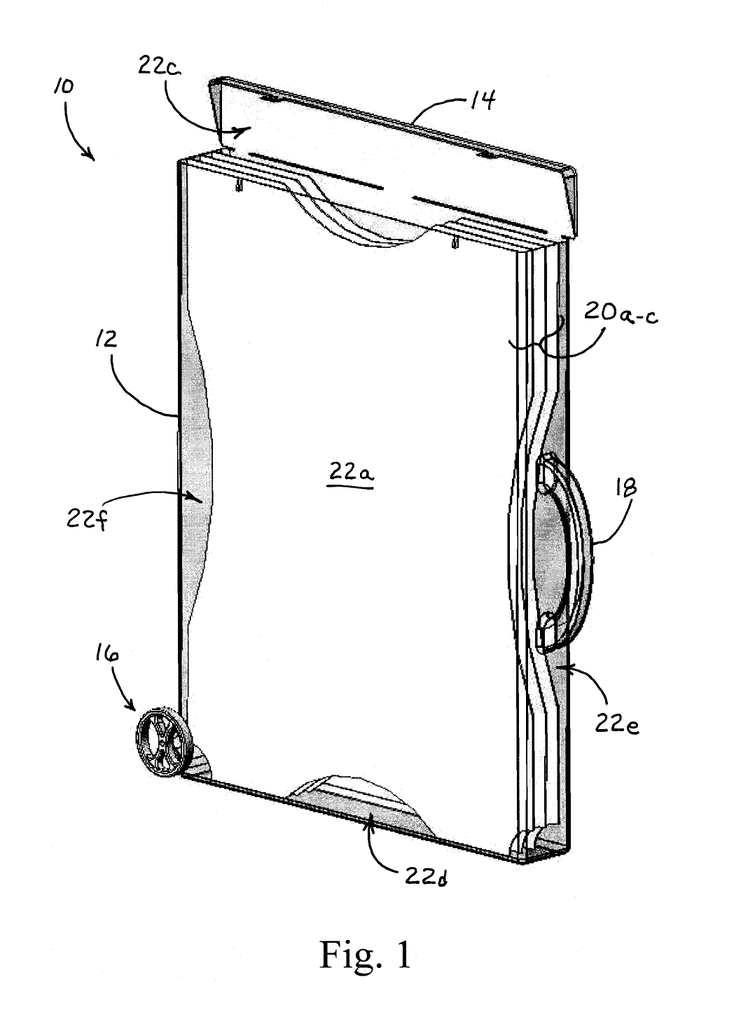

Reference is made first to FIG. 1 for a perspective view of a preferred embodiment of the poster case of the present invention as it would appear when positioned on a table or on the floor. As shown in FIG. 1, poster case 10 has case body 12 which is designed to be economically produced and may be of variable dimensions, shapes, and materials. Case 10 is preferably composed of a durable light-weight transparent plastic and constructed using one of the molding techniques well known in the art such as injection molding, blow molding, or rotational molding.

The case can be constructed in multiple sizes to accommodate a variety of standard paper or cardboard items typically used in a classroom. For convenience, each size may be a unique color.

Case lid 14 is attached to case body 12 and protects the stored items from dust, dirt, and spills. Lid 14 is hinged for easy opening and has a rim that may be fastened to the body of the case. Preferably, case lid 14 is formed from an extension of back face 22b of case body 12, with a scored bendable fold between case lid 14 and back face 22b. Thus, the hinge of lid 14 is preferably a scored bendable fold, but may alternately be a bendable plastic hinge, an acrylic hinge, a woven spine hinge, or a mechanical hinge. Case body 12 has six sides: front face 22a, back face 22b (not shown), top face 22c, and bottom face 22d, right side face 22e, and left side face 22f.

Continuing in FIG. 1, wheel assembly 16 is positioned at the bottom of case body 12 for easy rolling transport. The bottom of the case is flat and the wheel assembly 16 is offset from bottom face 22d to allow the teacher to stand the case on end for ease of access, display of contents, or safe storage.

The case handle 18 is attached to right side face 22e. Handle 18 is simply designed to allow the teacher to carry and transport case 10 with ease. Sides of case body 12 [front face 22a, back face 22b (not shown), top face 22c, and bottom face 22d] are clear for easily displaying items for teaching or identification of contents. The interior of case body 12 has multiple, clear dividers 20a-20c to allow the teacher to see the contents of the case and select an individual item quickly. The interior dividers are preferably fixed in position and composed of semi-rigid material that provides support for thin papers or other items that lack sufficient rigidity to stand alone.

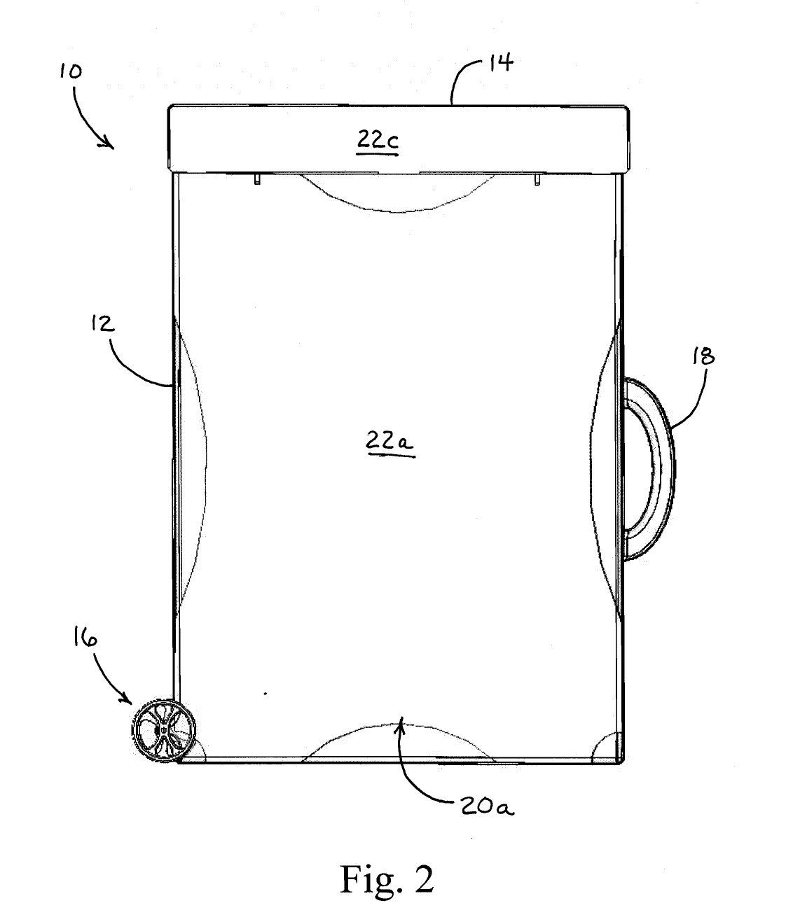

FIG. 2 illustrates a front elevation view of the preferred embodiment of the poster case 10 of the present invention shown in FIG. 1. FIG. 2 shows front face 22a with front divider 20a inside case body 12. Front divider 20a may be notched at one or more corners and perimeters in order to easily grip and remove a particular item from the case. Also shown is top face 22c which forms case lid 14, as well as handle 18 and wheel assembly 16.

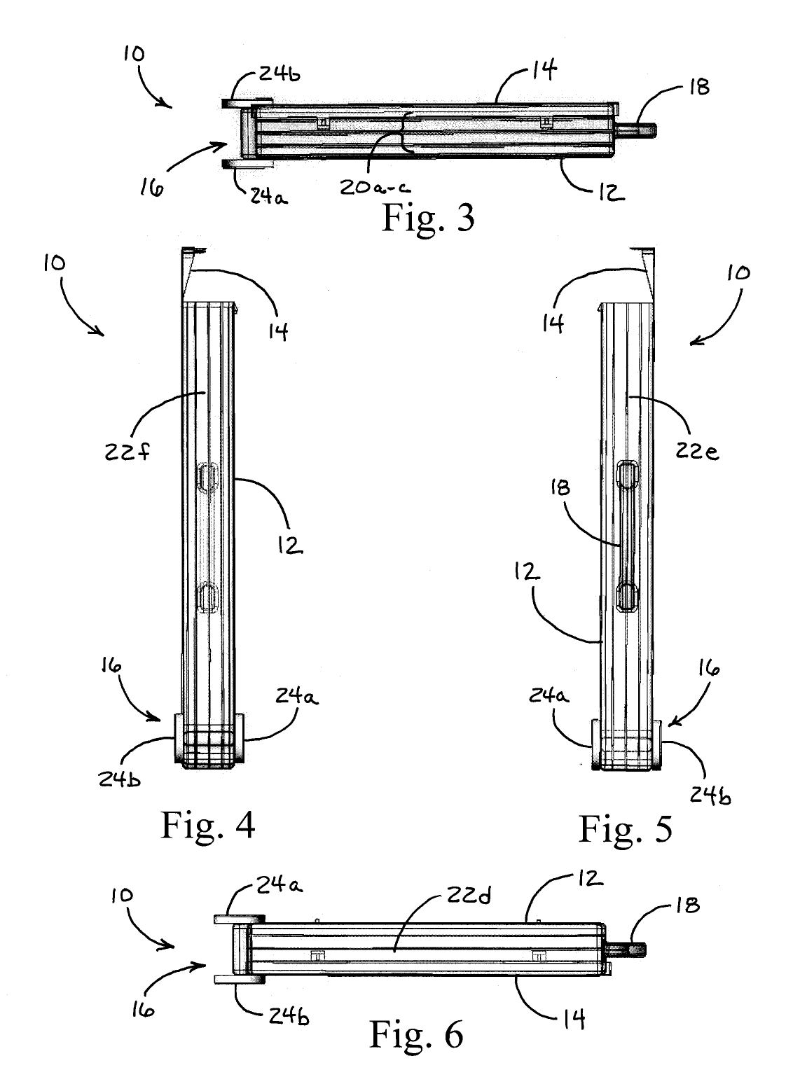

FIG. 3 shows a top plan view of poster case 10 with dividers 20a-20c within case body 12. Also shown is handle 18 and wheel assembly 16 with front wheel 24a and back wheel 24b.

Reference is next made to FIG. 4 which shows a left side elevation view of case 10 with open lid 14 and left side face 22f of case body 12. Also shown is wheel assembly 16 with front wheel 24a and back wheel 24f.

Continuing in FIG. 5 is a right side elevation view of case 10 with open lid 14 and right side face 22e of case body 12. Also shown is case handle 18, along with wheel assembly 16 having front wheel 24a and back wheel 24b.

As further disclosed in FIG. 6, the bottom plan view of case 10 illustrates the flat bottom face 22d of case body 12 to which is attached wheel assembly 16 with front wheel 24a and back wheel 24b. Also shown in FIG. 6 is the rim of lid 14 and the bottom view of case handle 18.

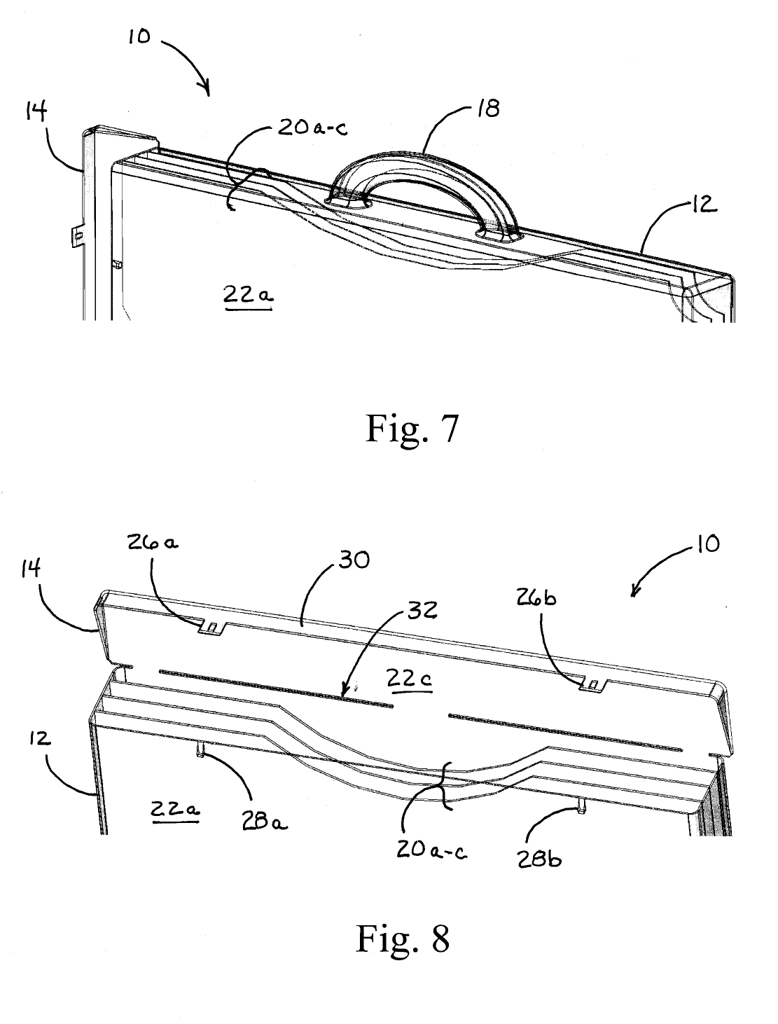

Continuing in FIG. 7 is a detailed perspective view of the handle side of case 10. Case body 12 is positioned in a carrying position with case handle 18 on top. Case lid 14 is open and dividers 20a-20c within case body 12 are clearly visible through front side 22a. As shown in FIG. 7, one or more corners and perimeters of dividers 20a-20c may be notched for improved ease in selecting and gripping an item from the materials within the case.

FIG. 8 illustrates a detailed perspective view of the lid opening top 14 of case 10. Lid 14 includes top face 22c, lid rim 30, and lid hinge 32. As shown in FIG. 8, front side 22a of case body 12 has two lid closure posts 28a and 28b which correspond to the lid closure tabs 26a and 26b on rim 30 of lid 14. To secure lid 14, the teacher simply folds lid 14 and secures tabs 26a and 26b onto posts 28a and 28b. In FIG. 8, dividers 20a-20c are visible within case body 12.

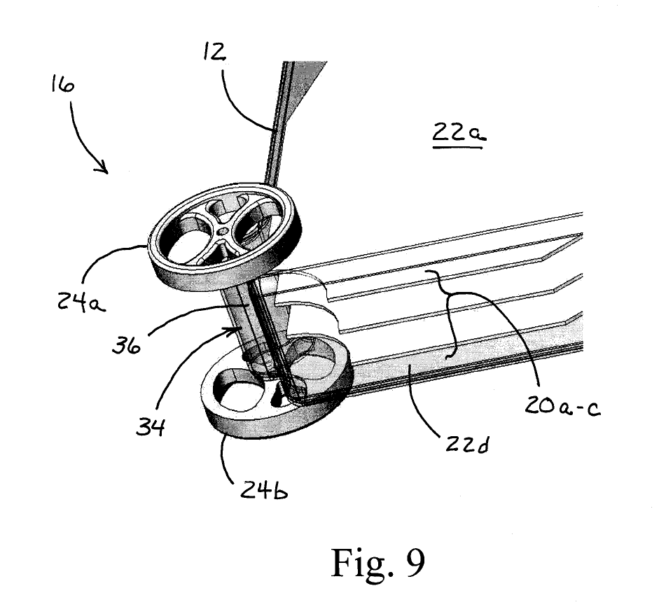

FIG. 9 illustrates a detailed perspective view of the wheel assembly 16 on case body 12. Once again, front face 22a is shown with dividers 20a-20c clearly visible through bottom face 22d. The housing for wheel assembly 16 is within a channel formed by left side face 22f. Wheel assembly 16 is shown in detail with axle cylinder 34 and axle shaft 36 attached to front wheel 24a and back wheel 24b. Wheel assembly 16 is held in place on case body 12 within the channel formed within left side face 22f. Wheel assembly 16 is positioned in association with left side face 22f such that when poster case body 12 is positioned on bottom face 22d, the wheel assembly 16 does not extend below the plane of bottom face 22d when positioned on a horizontal surface, so that the case body 12 stands upright. Alternately, wheel assembly 16 may be connected to case body 12 by other means known in the art such as plastic nuts and bolts or adhesive.

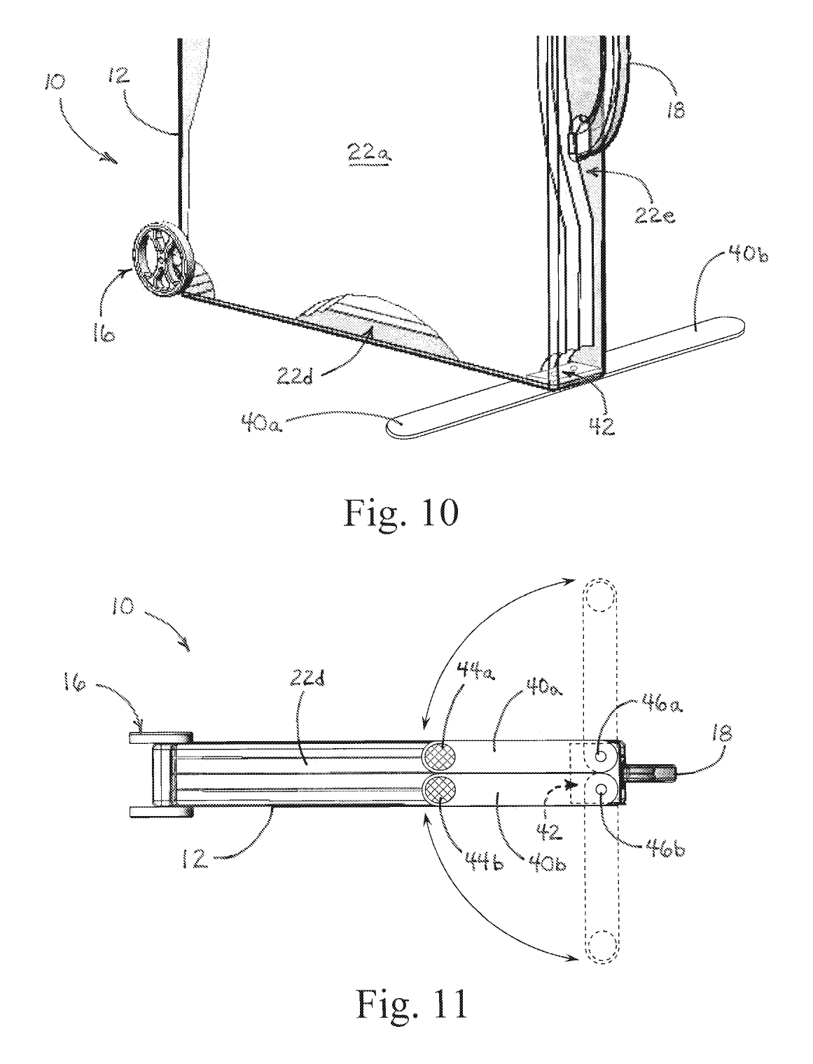

FIG. 10 illustrates a preferred embodiment of poster case 10 which incorporates stabilizer wings 40a and 40b on the bottom face 22d of poster case body 12. FIG. 10 illustrates poster case body 12 having front face 22a, bottom face 22d, and right side face 22e with handle 18. Wheel assembly 16 is positioned at one end of bottom face 22d of case body 12. Front side stabilizer wing 40a and back side stabilizer wing 40b are illustrated in the open position beneath bottom face 22d and attached to stabilizer attachment plate 42 in FIG. 10. Stabilizer attachment plate 42 is positioned within case body 12 on bottom face 22d.

FIG. 11 illustrates a bottom plan view of the preferred embodiment of poster case 10 which incorporates stabilizer wings 40a and 40b on the bottom face 22d of poster case body 12. The bottom plan view of FIG. 11 shows bottom face 22d with wheel assembly 16 and handle 18. Front side stabilizer wing 40a and back side stabilizer wing 40b are shown in the closed position on bottom face 22d. As shown by the broken lines in FIG. 11, the stabilizer wings 40a and 40b may be rotated from a stowed position fully within the perimeter of bottom face 22d to a stabilizing position approximately 90 degrees away from the stowed position to provide additional support for case body 12 when positioned on bottom face 22d. The stabilizer wings 40a and 40b are held in place with attachment rivet and post 46a and 46b which are punched through bottom face 22d and stabilizer attachment plate 42 of case body 12. As shown in FIG. 11, front side stabilizer wing 40a is attached to bottom face 22d and stabilizer attachment plate 42 by attachment rivet and post 46a. Back side stabilizer wing 40b is attached to bottom face 22d and stabilizer attachment plate 42 by attachment rivet and post 46b. Also shown in FIG. 11 is non-slip stabilizer pad 44a on front side stabilizer wing 40a and non-slip stabilizer pad 44b on back side stabilizer wing 40b. Stabilizer pads 44a and 44b are attached with adhesive or other methods known in the art to stabilizer wings 40a and 40b. Stabilizer pads 44a and 44b provide additional friction for stabilizer wings 40a and 40b to further enhance the overall stability of case body 12 when positioned on bottom face 22d.

As described above, all sides of case body 12 as well as the dividers 20a-20c inside the case are lightweight and transparent. The handle and wheel assembly are also lightweight. Various alternate embodiments of the carrying case include different attachment means for the lid and wheel assembly. Another embodiment includes a case with the lid positioned on the side of the body of the case rather than the top. An alternate embodiment includes a hinge positioned between two case bodies to form a single case in closed position.

Changes in the precise embodiments of the invention herein disclosed can be made within the scope of what is claimed without departing from the spirit of the invention. Other designs may be evident to those skilled in the art upon viewing this device. Although the present invention has been described in conjunction with a number of preferred embodiments, those skilled in the art will recognize modifications to these embodiments that still fall within the spirit and scope of the present invention.

I claim:

1. A poster storage, display and carrying case particularly suited to the needs of classroom teachers, the case comprising:
a case body comprising a rectangular solid shell open on one face and having a front face, a back face, a first side face, a second side face, and a bottom face;
a case lid hingedly positioned on the case body so as to close the open face;
at least one generally rectangular divider positioned within the case body;
a wheel assembly positioned adjacent to the bottom face of the case body; and
a handle;
wherein one or more posters may be inserted on one side of the at least one divider within the case body through the open face and secured therein by closing of the case lid.

2. The poster storage, display and carrying case of claim 1, wherein the case body and the at least one divider comprise transparent material.

3. The poster storage, display and carrying case of claim 1, wherein the case body and the at least one divider comprise polymer plastic sheet material.

4. The poster storage, display and carrying case of claim 1, wherein the case lid comprises a rim and at least one lid closure tab and the front face of the case body comprises at least one lid closure post aligned with the at least one lid closure tab.

5. The poster storage, display and carrying case of claim 4, wherein the at least one closure tab comprises two lid closure tabs positioned on the rim of the case lid and the at least one lid closure post comprises two lid closure posts.

6. The poster storage, display and carrying case of claim 1, wherein the wheel assembly is positioned in association with a side face such that when the poster case is positioned on its bottom face on a horizontal surface, the wheel assembly does not extend below the plane of the bottom face, whereby the case body stands upright.

7. The poster storage, display and carrying case of claim 1, wherein the wheel assembly comprises two wheels, an axle shaft, and an axle cylinder.

8. The poster storage, display and carrying case of claim 7, wherein the axle cylinder is formed from a side face of the case body.

9. The poster storage, display and carrying case of claim 7, wherein the axle cylinder is attached to a side face of the case body.

10. The poster storage, display and carrying case of claim 1, wherein the at least one divider is fixedly attached to the case body.

11. The poster storage, display and carrying case of claim 1, wherein the at least one divider is notched on at least one perimeter edge whereby the user may view the presence of a poster between the divider and the case body.

12. The poster storage, display and carrying case of claim 11, wherein the at least one divider is notched on each perimeter edge whereby the user may view the presence of a poster between the divider and the case body from any face of the case body.

13. The poster storage, display and carrying case of claim 1, wherein the case lid comprises an extension of the back face of the case body with a scored bendable fold between the case lid and the back face.

14. The poster storage, display and carrying case of claim 1, wherein the handle is positioned on a side face.

15. The poster storage, display and carrying case of claim 1, wherein the handle is positioned on the case lid.

16. The poster storage, display and carrying case of claim 1, wherein the bottom face comprises at least two stabilizer wings.

17. The poster storage, display and carrying case of claim 16, wherein the at least two stabilizer wings comprise at least two flat bars each pivotably attached to the bottom face and rotatable from a stowed position fully within the perimeter of the bottom face to a position 90 degrees from the stowed position.

18. A poster storage, display and carrying case particularly suited to the needs of classroom teachers, the case comprising:
a case body comprising transparent polymer plastic sheet material forming a rectangular solid shell open on one face and having a front face, a back face, a first side face, a second side face, and a bottom face, wherein the front face has two closure posts;
a case lid comprising an extension of the back face of the case body with a scored bendable fold between the case lid and the back face, whereby the case lid is hingedly positioned on the case body so as to close the open face of the case body, and further comprising a rim, and two closure tabs that align with the two closure posts of the front face of the case body;
a plurality of generally rectangular dividers comprising transparent polymer plastic sheet material positioned within the case body and fixedly attached to the case body, the plurality of dividers notched on at least one perimeter edge, whereby the user may view the presence of a poster between the dividers or between a divider and the case body;
a wheel assembly positioned adjacent to the bottom face of the case body, the wheel assembly comprising two wheels, an axle shaft, and an axle cylinder; the axle cylinder formed from a side face of the case body, the wheel assembly positioned in association with a side face such that when the poster case is positioned on its bottom face on a horizontal surface, the wheel assembly does not extend below the plane of the bottom face, whereby the case body stands upright; and
a handle positioned on a side face;
wherein one or more posters may be inserted on one side of a divider within the case body through the open face and secured therein by closing of the case lid.
